(19) United States
(12) Patent Application Publication
(10) Pub. No.: US 2020/0183674 A1
(43) Pub. Date: Jun. 11, 2020

(54) ON-BOARD UPDATE DEVICE, ON-BOARD UPDATE SYSTEM, AND COMMUNICATION DEVICE UPDATE METHOD

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka (JP)

(72) Inventors: Hiroshi Tateishi, Yokkaichi, Mie (JP); Hiroshi Ueda, Yokkaichi, Mie (JP); Masayuki Inoue, Yokkaichi, Mie (JP); Tomohiro Mizutani, Yokkaichi, Mie (JP)

(21) Appl. No.: 16/322,552

(22) PCT Filed: Jul. 24, 2017
(86) PCT No.: PCT/JP2017/026642

§ 371 Date: Feb. 1, 2019

(30) Foreign Application Priority Data
Aug. 5, 2016 (JP) 2016-154465

(51) Int. Cl. G06F 8/65; B60R 16/023

(52) U.S. Cl. CPC G06F 8/65; B60R 16/023

(57) ABSTRACT

An on-board update device includes: an update information acquisition unit which acquires data from a device outside a vehicle. A prohibition processing unit prohibits communication between each of the communication devices to be updated and any other communication device. An update information transmission unit transmits the data acquired by the update information acquisition unit, via one or more in-vehicle communication units to the corresponding communication devices to be updated, after the prohibition processing unit has prohibited communication; a completion decision unit decides whether each of the communication devices to be updated has completed an update of the program or data; and a prohibition cancelling unit cancels the prohibition of communication between each of the communication devices to be updated and any other communication device, if the completion decision unit decides that all of the communication devices to be updated have completed their updates.

### CROSS-REFERENCE TO RELATED APPLICATIONS

This application is the U.S. national stage of PCT/JP2017/026642 filed Jul. 24, 2017, which claims priority of Japanese Patent Application No. JP 2016-154465 filed Aug. 5, 2016.

### TECHNICAL FIELD

The present disclosure relates to an on-board update device, an on-board update system, and a communication device update method, for updating programs or data in communication devices installed in a vehicle.

### BACKGROUND

A vehicle is conventionally equipped with a plurality of communication devices such as ECUs (Electronic Control Units), which are connected via communication lines such as CAN (Controller Area Network) buses and thereby capable of transmitting and receiving information to/from each other. In each ECU that is in charge of vehicle control or a like process, a processor such as a CPU (Central Processing Unit) retrieves and executes a program stored in a storage unit such as a flash memory or EEPROM (Electrically Erasable Programmable Read Only Memory). The program or data stored in the storage unit of each ECU needs to be updated with a new program or data, for example, when required to add a function, to correct a fault, to upgrade, etc. In this case, an update program or data is transmitted via a communication line to the ECU to be updated.

In a program update system proposed by JP 2015-103163A, update data for a control device to be updated contain not only an update control program for the control device but also a computer program that enables means for calculating a digest value relating to the update control program, means for deciding whether the updated control device operates normally, and means for returning the result of the decision. The control device to be updated receives the update data, and updates the control program with the update control program contained in the received update data. Then, the control device runs the computer program and decides whether the updated control device operates normally, thus being capable of checking the validity of the program update.

The target of the program or data update process is not always only one of the communication devices installed in a vehicle. For example, if the format or ID of a message transmitted and received between a plurality of communication devices has been changed, all communication devices that transmit and receive this message need updating. In this case, the update processes in the communication devices proceed simultaneously or sequentially in the vehicle, but such update processes start and end at different timing from one device to another. Hence, for example, an attempt to establish communication between a communication device that has completed an update process and another communication device that has not completed an update process may lead to a trouble in either or both of these communication devices.

The present disclosure is made in view of such circumstances, and intends to provide an on-board update device, an on-board update system, and a communication device update method capable of updating a plurality of communication devices without trouble.

### SUMMARY

An on-board update device according to an aspect of the present disclosure has one or more in-vehicle communication units for communicating with a plurality of communication devices installed in a vehicle, and updates a program or data stored in a storage unit of each communication device. This on-board update device includes: an update information acquisition unit which acquires one or more update programs or data from a device outside the vehicle; a prohibition processing unit which, if more than one of the communication devices needs updating, prohibits communication between each of the communication devices to be updated and any other communication device; an update information transmission unit which transmits the one or more update programs or data acquired by the update information acquisition unit, via the one or more in-vehicle communication units to the corresponding communication devices to be updated, after the prohibition processing unit has prohibited communication; a completion decision unit which decides whether each of the communication devices to be updated has completed an update of the program or data; and a prohibition cancelling unit which cancels the prohibition of communication between each of the communication devices to be updated and any other communication device, if the completion decision unit decides that all of the communication devices to be updated have completed their updates.

The on-board update device according to another aspect of the present disclosure further includes a pre-update information acquisition unit which acquires pre-update programs or data stored in the storage units of the communication devices to be updated, and a pre-update information storage unit which stores the programs or data acquired by the pre-update information acquisition unit. The pre-update information storage unit stores the programs or data of the communication devices to be updated, until the completion decision unit decides that the communication devices to be updated have completed the updates.

The on-board update device according to another aspect of the present disclosure further includes a failure decision unit which decides whether any of the communication devices to be updated has failed in their update process, and a pre-update information transmission unit which transmits, when the failure decision unit decides that any of the communication devices to be updated has failed in their update, the programs or data stored in the pre-update information storage unit to the corresponding communication devices to be updated.

The on-board update device according to another aspect of the present disclosure further includes an IG (ignition) state acquisition unit which acquires a state of an IG signal in the vehicle. The update information acquisition unit acquires the one or more update programs or data when the IG signal is on. The update information transmission unit transmits the one or more update programs or data when the IG signal is off or when the IG signal has changed from off to on.

The on-board update device according to another aspect of the present disclosure further includes a battery information acquisition unit which acquires information on a battery level of the vehicle. The update information transmission unit decides when to transmit the update programs or data, from when the IG signal is off or when the IG signal has changed from off to on, depending on the battery level acquired by the battery information acquisition unit.

The on-board update device according to another aspect of the present disclosure further includes a time information acquisition unit which acquires time-related information. The update information transmission unit transmits the update programs or data, according to the information acquired by the time information acquisition unit.

An on-board update system according to another aspect of the present disclosure includes a plurality of communication devices installed in a vehicle, one or more in-vehicle communication units for communicating with the communication devices, and an on-board update device for updating a program or data stored in a storage unit of each communication device. In this on-board update system, the on-board update device includes: an update information acquisition unit which acquires one or more update programs or data from a device outside the vehicle; a prohibition processing unit which, if more than one of the communication devices needs updating, prohibits communication between each of the communication devices to be updated and any other communication device; an update information transmission unit which transmits the one or more update programs or data acquired by the update information acquisition unit, via the one or more in-vehicle communication units to the corresponding communication devices to be updated, after the prohibition processing unit has prohibited communication; a completion decision unit which decides whether each of the communication devices to be updated has completed an update of the program or data; and a prohibition cancelling unit which cancels the prohibition of communication between each of the communication devices to be updated and any other communication device, if the completion decision unit decides that all of the communication devices to be updated have completed their updates. Each of the communication devices includes an update information receiving unit for receiving an update program or data from the on-board update device, and an update processing unit for performing an update by storing the update program or data received by the update information receiving unit. Each of the communication devices stops data transmission to any other communication device if the on-board update device prohibits the communication.

In the on-board update system according to another aspect of the present disclosure, the storage unit in each communication device at least includes a first area for storing a pre-update program or data, and a second area for storing an update program or data. In the second area, the update processing unit of each communication device stores the update program or data received by the update information receiving unit. When the update program or data is completely stored in the second area, the update processing unit of each communication device invalidates the pre-update program or data stored in the first area.

A communication device update method according to another aspect of the present disclosure is a method for updating a program or data stored in a storage unit in each of a plurality of communication devices installed in a vehicle. This method includes the steps of acquiring one or more update programs or data from a device outside the vehicle; if more than one of the communication devices needs updating, prohibiting communication between each of the communication devices to be updated and any other communication device; after the communication is prohibited, transmitting the one or more acquired update programs or data to the corresponding communication devices to be updated; deciding whether the communication devices to be updated have completed updates of the corresponding programs or data; and if the decision step decides that all of the communication devices to be updated have completed the respective updates, cancelling the prohibition of communication between each of the communication devices to be updated and any other communication device.

In the present disclosure, the on-board update device performs the update processes of the programs or data in the plurality of communication devices installed in a vehicle. The on-board update device acquires update programs or data from the server device or a like device installed outside the vehicle. If more than one communication device needs updating, the on-board update device acquires an update program or data for each communication device. Alternatively, the on-board update device may apply a single update program or a single set of data to the update process of more than one communication device.

If more than one communication device needs updating, the on-board update device prohibits each communication device to be updated from communicating with any other communication device, prior to the start of the update process of each communication device. As an exception, communication indispensable for the update process (i.e., communication between the on-board update device and each of the communication devices to be updated) may be permitted. After prohibiting the communication, the on-board update device transmits the update programs or data to the corresponding communication devices to be updated. The communication devices that have respectively received the update programs or data from the on-board update device perform updates of their programs or data by storing the received update programs or data in their storage units. When the on-board update device decides that all of the communication devices to be updated have completed the update processes, the on-board update device cancels the prohibition of communication in these communication devices. Once the prohibition of communication is cancelled, the communication devices provided with the updated programs or data start to communicate with any other communication device.

As described above, if more than one communication device needs to be updated simultaneously, this configuration prohibits communication between these communication devices until all of the communication devices have completed their update processes. It is therefore possible to prevent a trouble caused by communication between a communication device which has completed an update process and another communication device which has not completed an update process.

In the present disclosure, the on-board update device also acquires the pre-update programs or data stored in the storage units of the communication devices to be updated, and stores the pre-update programs or data until the communication devices have completed their update processes. If an update process has failed in any of the communication devices, the on-board update device transmits the stored pre-update program or data to this communication device. Eventually, the communication device that has failed in the update process can acquire the pre-update program or data from the on-board update device, and can return to the pre-update state.

In the present disclosure, the on-board update device also acquires the state of an IG (ignition) signal in the vehicle. If the IG signal is on, the on-board update device acquires the programs or data from the external device. Later, when the IG signal is off or when the IG signal has changed from off to on, the on-board update device performs the update processes of the communication devices, using the acquired programs or data. In the thus configured on-board update device, the programs or data can be acquired from the external device while the engine or a like part of the vehicle is in operation to ensure sufficient power supply, and the update processes of the communication devices can be performed while the vehicle is not moving or before the vehicle starts moving.

In the present disclosure, the on-board update device acquires information on the battery level of the vehicle. Based on the battery level, the on-board update device decides when to perform the update processes of the communication devices, from when the IG signal is off or when the IG signal has changed from off to on. For example, if the battery level is high, the on-board update device performs the update processes when the IG signal is off. If the battery level is low, the on-board update device performs the update processes when the IG signal has changed from off to on. This configuration can prevent, for example, the battery from running out during the update processes, or other like problems.

In the present disclosure, the on-board update device further acquires time information and performs the update processes according to the time information. For example, the on-board update device performs the update processes at the time when the user is unlikely to use the vehicle (e.g., 3:00 a.m.). Eventually, the user is less likely to intend to use the vehicle while the update processes of the communication devices are in progress.

In the present disclosure, the storage unit in each communication device at least includes a first area for storing a pre-update program or data and a second area for storing an update program or data. Namely, the storage unit of each communication device has a storage area that is capable of storing at least two sets of program or data. The communication device receives the update program or data transmitted for the update process from the on-board update device, and stores the received update program or data in the area (the second area) different from the area (the first area) storing the pre-update program or data. Thus, each communication device stores its update program or data in the storage unit, without overwriting the pre-update program or data. After storing the update program or data, each communication device invalidates the pre-update program or data and validates the update program or data, thereby completing the update process. The pre-update program or data stored in the first area enables the communication device that has failed in the update process to keep the pre-update state.

### Advantageous Effects of Disclosure

The present disclosure prohibits mutual communication of a plurality of communication devices to be updated, until all of the communication devices have completed the respective update processes. The present disclosure can thereby prevent a trouble caused by communication between a communication device that has completed an update process and another communication device that has not completed an update process, and can accomplish the update processes without trouble.

### BRIEF DESCRIPTION OF DRAWINGS

FIG. 1 is a schematic view showing the configuration of an on-board update system according to the Embodiments.

FIG. 2 is a block diagram showing the configuration of an ECU 2.

FIG. 3 is a block diagram showing the configuration of a gateway.

FIG. 4 is a flowchart of an update process, showing process steps performed by the gateway.

FIG. 5 is a flowchart of the update process, showing process steps performed by each ECU.

FIG. 6 is a flowchart of the update process, showing process steps performed by the gateway according to Embodiment 2.

FIG. 7 is a flowchart of the update process, showing process steps performed by each ECU according to Embodiment 2.

FIG. 8 is a schematic view for describing the update process performed by each ECU according to Embodiment 3.

FIG. 9 is a flowchart of the update process, showing process steps performed by the gateway in an on-board update system according to Embodiment 4.

### DETAILED DESCRIPTION OF PREFERRED EMBODIMENTS

### Embodiment 1

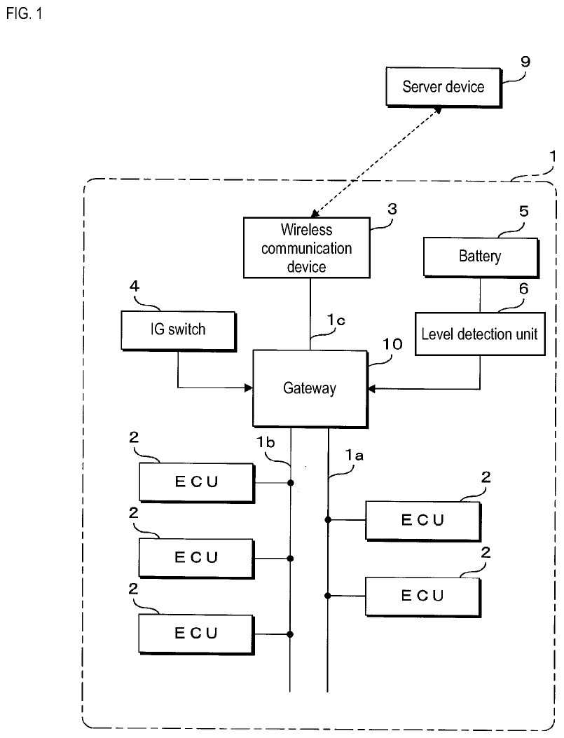

FIG. 1 is a schematic view showing the configuration of an on-board update system according to the Embodiments. In the on-board update system according to the Embodiments, a vehicle 1 is equipped with a plurality of ECUs (Electronic Control Units) 2, which communicate with each other via communication lines 1a, 1b and a gateway 10 arranged in the vehicle 1. In the on-board update system according to the Embodiments, the gateway 10 corresponds to an on-board update device, and the ECUs 2 correspond to communication devices. In the system configuration of the illustrated example, two ECUs 2 are connected to the in-vehicle communication line 1a, and three ECUs 2 are connected to the in-vehicle communication line 1b, with the two communication lines 1a, 1b being connected to the gateway 10. The gateway 10 relays communication between the communication lines 1a, 1b and thereby enables mutual transmission and reception of data in all ECUs 2.

In the on-board update system according to this embodiment, a wireless communication device 3 is also connected to the gateway 10 via a communication line 1c. Via the wireless communication device 3, the gateway 10 can communicate with a server device 9 installed outside the vehicle 1. The gateway 10 further receives an IG signal from an IG switch 4 in the vehicle 1 and a detection result from a battery level detection unit 6 that detects the level of a battery 5 in the vehicle 1.

The ECUs 2 may include various kinds of ECUs such as an ECU that controls the engine operation of the vehicle 1, an ECU that controls locking/unlocking of the doors, an ECU that controls on/off of the lighting, an ECU that controls the airbag operation, and an ECU that controls the ABS (Antilock Brake System) operation. Each ECU 2 is connected to the communication line 1a or 1b arranged in the vehicle 1, and is capable of transmitting data to and receiving data from the other ECUs 2 and the gateway 10 via the communication lines 1a, 1b.

The wireless communication device 3 can transmit information to and receive information from the server device 9, for example, by wireless communication on a mobile telephone communication network, a wireless LAN (Local Area Network), or the like. The wireless communication device 3, which is connected to the gateway 10 via the communication line 1c, can transmit information to and receive information from the gateway 10 by wired communication. Thus, the wireless communication device 3 can relay the communication between the gateway 10 and the server device 9, by transmitting the data provided from the gateway 10 to the server device 9 and providing the data received from the server device 9 to the gateway 10.

The gateway 10 is connected with the communication lines 1a-1c that constitute an in-vehicle network for the vehicle 1, and relays data transmitted and received on these communication lines. In the example of FIG. 1, the gateway 10 is connected with three communication lines 1a-1c, namely, the first communication line 1a connected with two ECUs 2, the second communication line 1b connected with three ECUs 2, and the third communication line 1c connected with the wireless communication device 3. The gateway 10 relays data by receiving data from any of the communication lines 1a-1c and transmitting the received data to the other communication lines 1a-1c.

The IG switch 4, which is a user-operated switch to start the engine of the vehicle 1 or to perform a like operation, changes over between two states, i.e., between on and off. In the Embodiments, the IG signal indicates the state of the IG switch 4. When the IG signal indicates on, the motor of the vehicle 1 (e.g., an engine) is in operation, and an alternator or the like is generating power. When the IG signal indicates off, the motor of the vehicle 1 is not in operation, and an alternator or the like generates no power. The battery level detection unit 6 detects the amount of electricity charged in the battery 5, for example, based on the voltage value at the output terminal of the battery 5 and/or the accumulated value of the input/output current at the battery 5.

The server device 9 manages and stores the programs and data to be executed by the ECUs 2 installed in the vehicle 1. In response to an inquiry from the vehicle 1, the server device 9 informs the vehicle whether any program or the like needs updating. If an update is necessary, the server device 9 delivers an update program and data to the vehicle 1.

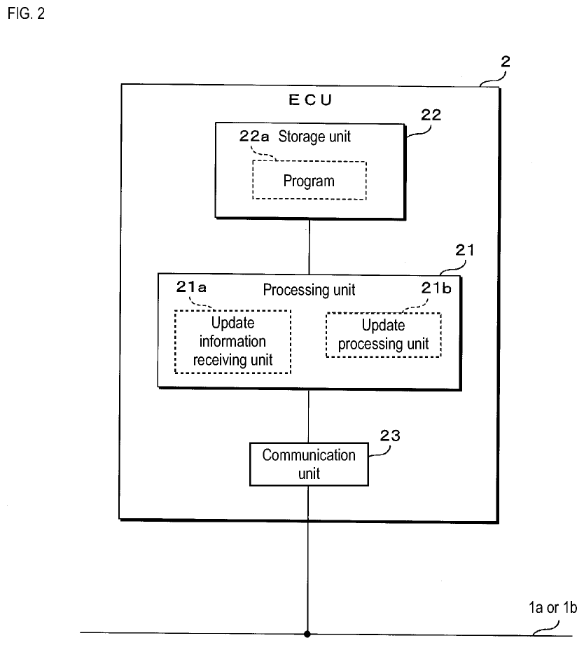

FIG. 2 is a block diagram showing the configuration of the ECU 2. This diagram focuses on the functional blocks common to the plurality of ECUs 2, and omits the functional blocks that are different in every ECU 2. Each of the ECUs 2 according to the present embodiment includes a processing unit 21, a storage unit 22, and a communication unit 23, for example. The processing unit 21 is configured, for example, by an arithmetic processing unit such as a CPU (Central Processing Unit) or an MPU (Micro-Processing Unit). The processing unit 21 performs various arithmetic operations by retrieving and running a program 22a stored in the storage unit 22. The program 22a stored in the storage unit 22 is different in every ECU 2.

The storage unit 22 is configured with use of a non-volatile memory device such as a flash memory or EEPROM (Electrically Erasable Programmable Read Only Memory). The storage unit 22 stores not only the program 22a to be executed by the processing unit 21 but also data necessary for execution of the program 22a. Hereinafter, the term “program 22a” may encompass the program 22a and the data necessary for execution of the program 22a.

The communication unit 23 is connected with the communication line 1a or 1b that constitutes the in-vehicle network, and transmits and receives data pursuant to, for example, a communication protocol such as CAN (Controller Area Network). To transmit data, the communication unit 23 converts the data given from the processing unit 21 into an electric signal, and outputs the converted data signal to the communication line 1a or 1b. To receive data, the communication unit 23 samples an electrical potential at the communication line 1a or 1b, and supplies the thus received data to the processing unit 21.

The processing unit 21 of the ECU 2 according to the present embodiment includes an update information receiving unit 21a and an update processing unit 21b. The update information receiving unit 21a and the update processing unit 21b are functional blocks for updating the program 22a stored in the storage unit 22. The update information receiving unit 21a and the update processing unit 21b are software-like functional blocks that are enabled when the processing unit 21 executes a program (illustration omitted) different from the program 22a to be updated. The update information receiving unit 21a receives an update program transmitted via the communication line 1a or 1b through the communication unit 23, and accumulates the received update program in a buffer memory or the like (illustration omitted). The update processing unit 21b updates the program 22a by storing in the storage unit 22 (overwriting on the pre-update program 22a) the update program accumulated in the buffer memory or the like.

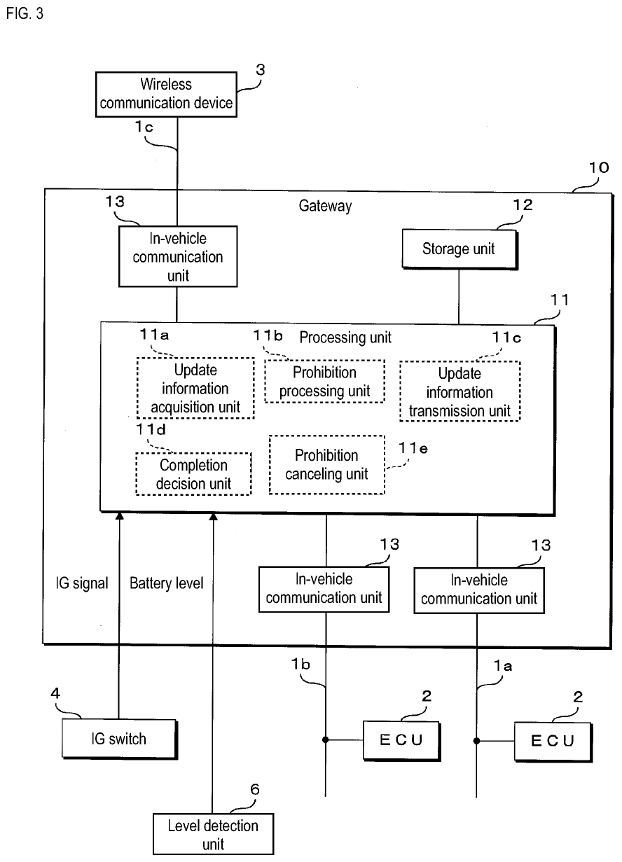

FIG. 3 is a block diagram showing the configuration of the gateway 10. The gateway 10 according to the present embodiment includes a processing unit 11, a storage unit 12, three in-vehicle communication units 13, etc. The processing unit 11 is configured, for example, by an arithmetic processing unit such as a CPU or an MPU. The processing unit 11 performs various arithmetic operations by retrieving and running a program stored in the storage unit 12, ROM (Read Only Memory) (not shown), or the like. In the present embodiment, the processing unit 11 relays the data transmitted and received on the communication lines 1a-1c that constitute the in-vehicle network, and performs arithmetic operations necessary for the update processes of the ECUs 2 or for other purposes. The processing unit 11 also receives the IG signal from the IG switch 4 in the vehicle 1 and the battery level of the battery 5 from the battery level detection unit 6. In this regard, in-vehicle communication through the communication lines 1a-1c may be also utilized to input the IG signal and/or the battery level to the gateway 10.

The storage unit 12 is configured with use of a non-volatile memory device such as a flash memory or EEPROM. The storage unit 12 stores, for example, the programs to be executed by the processing unit 11, data necessary for execution of the programs, and the like. The storage unit 12 also stores data generated during the processing in the processing unit 11.

The in-vehicle communication units 13 are connected one by one with the communication lines 1a-1c that constitute the in-vehicle network, and transmit and receive data pursuant to, for example, a communication protocol such as CAN. To transmit information, the in-vehicle communication units 13 convert the data given from the processing unit 11 into electric signals, and output the converted data signals to the communication lines 1a-1c. To receive data, the in-vehicle communication units 13 sample electrical potentials at the communication lines 1a-1c, and supply the thus received data to the processing unit 11. The three in-vehicle communication units 13 provided in the gateway 10 may follow different communication protocols.

The processing unit 11 executes the programs stored in the storage unit 12, ROM, or the like, and thereby enables software-like functional blocks such as an update information acquisition unit 11a, a prohibition processing unit 11b, an update information transmission unit 11c, a completion decision unit 11d, and a prohibition cancelling unit 11e. The update information acquisition unit 11a establishes communication with the server device 9 via the wireless communication device 3 at a predetermined timing, and asks whether the programs 22a in the ECUs 2 installed in the vehicle 1 need updating. The predetermined timing for asking the necessity of updates may be a prescribed cycle (e.g., every day or every week) or, for example, every time the IG switch 4 is changed from off to on. When informed by the server device 9 that one or more updates are necessary, the update information acquisition unit 11a acquires one or more programs, data, etc. necessary for the updates (hereinafter simply called as “update program(s)”) from the server device 9 via the wireless communication device 3, and stores the update programs in the storage unit 12. The update information acquisition unit 11a acquires update programs for all of the ECUs 2 that need updating.

Prior to the start of the update process of the program 22a in each ECU 2, the prohibition processing unit 11b gives a communication prohibition command to prohibit communication between each ECU 2 to be updated and the other ECUs 2. This command is transmitted to one or more ECUs 2 to be updated, via the one or more corresponding in-vehicle communication units 13. Each ECU 2 that has received the communication prohibition command from the gateway 10 stops communication with the other ECUs 2 until receiving a command to cancel the prohibition of communication from the gateway 10. As an exception, communication indispensable for the update process (e.g., communication with the gateway 10) is permitted even after the ECU 2 has received the communication prohibition command.

After the prohibition processing unit 11b has transmitted the communication prohibition command, the update information transmission unit 11c retrieves the update program that has been acquired from the server device 9 and stored in the storage unit 22, and transmits the retrieved update program to the corresponding ECU 2 to be updated. If more than one ECU 2 needs updating, the update information transmission unit 11c transmits the update programs in a proper order, to all of the ECUs 2 to be updated. Each ECU 2 that has received the update program from the gateway 10 updates the program 22a by overwriting the pre-update program 22a stored in the storage unit 22 with the received update program.

On completing an update of the program 22a in the storage unit 22, each ECU 2 notifies the gateway 10 that the update is complete. In the gateway 10, the completion decision unit 11d of the processing unit 11 receives an update completion report from each ECU 2 via the in-vehicle communication unit 13. The completion decision unit 11d checks whether it has received the update completion reports from all of the ECUs 2 to be updated, and thereby decides whether the update processes are complete.

If the completion decision unit 11d decides that the update processes are complete, the prohibition cancelling unit 11e transmits a command to cancel the prohibition of communication, via the in-vehicle communication unit 13, to each ECU 2 that has been prohibited from communication. The ECU 2 that has received the communication prohibition cancel command from the gateway 10 may start to communicate with the other ECUs 2.

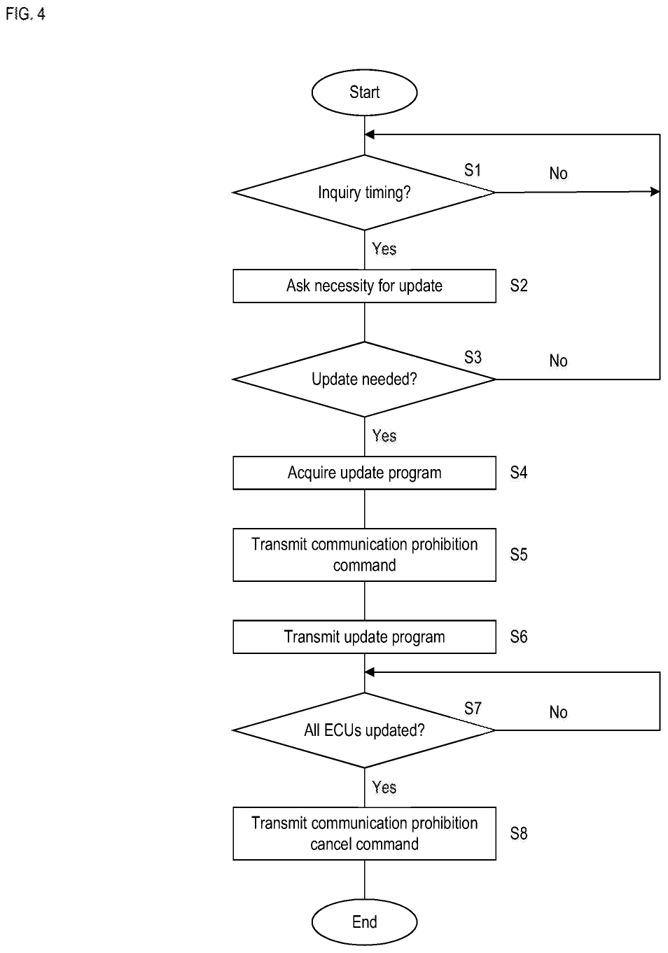

FIG. 4 is a flowchart of an update process, showing process steps performed by the gateway 10. In the gateway 10 according to the present embodiment, the update information acquisition unit 11a of the processing unit 11 decides whether it is the timing to ask the necessity of updates to the server device 9, for example, whether a predetermined period has passed since the previous inquiry or whether the IG switch 4 is changed from off to on (Step S1). If it is not the inquiry timing (No in Step S1), the update information acquisition unit 11a waits until the timing of inquiry comes.

If the inquiry timing has come (YES in Step S1), the update information acquisition unit 11a asks the external server device 9, by wireless communication via the wireless communication device 3, whether any of the programs 22a in the ECUs 2 installed in the vehicle 1 needs updating (Step S2). Based on a response from the server device 9 to this inquiry, the update information acquisition unit 11a decides whether any of the programs 22a needs updating (Step S3). If no program 22a needs updating (NO in Step S3), the process goes back to Step S1. If one or more programs 22a need updating (YES in Step S3), the update information acquisition unit 11a requests the server device 9 to transmit one or more corresponding update programs, by wireless communication via the wireless communication device 3. In response to this request, the server device 9 transmits the update programs to the update information acquisition unit 11a. The update information acquisition unit 11a receives and stores the update programs in the storage unit 12 (Step S4).

After the gateway 10 has received the update program, the prohibition processing unit 11b in the processing unit 10 gives a communication prohibition command to prohibit communication between each ECU 2 to be updated and the other ECUs 2. This command is transmitted to each ECU 2 to be updated, via the corresponding in-vehicle communication unit 13 (Step S5). Next, the update information transmission unit 11c of the processing unit 11 transmits the update program that has been acquired from the server device 9 and stored in the storage unit 12, to the corresponding ECU 2 to be updated (Step S6). If more than one ECU 2 needs updating and more than one update program is stored, the update information transmission unit 11c may transmit the multiple update programs in any sequence or in parallel.

The completion decision unit 11d of the processing unit 11 checks whether it has received update completion reports from all of the ECUs 2 to be updated, and thereby decides whether all of the ECUs 2 have completed their update processes (Step S7). If not all of the ECUs 2 have completed the update processes (NO in Step S7), the completion decision unit 11d waits until all of the ECUs 2 have completed the update processes. If all of the ECUs 2 have completed the update processes (YES in Step S7), the prohibition cancelling unit 11e of the processing unit 11 transmits a communication prohibition cancel command to cancel the prohibition of communication, to every ECU 2 to which the communication prohibition command has been transmitted in Step S5 (Step S8). Then, the process ends.

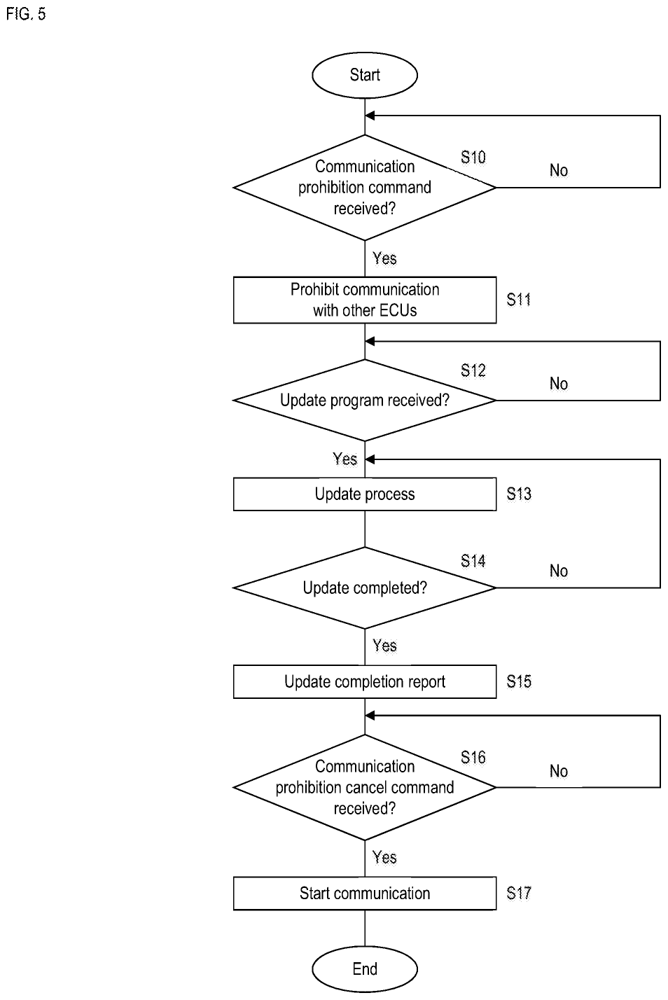

FIG. 5 is a flowchart of the update process, showing process steps performed by each ECU 2. In the present embodiment, the processing unit 21 in the ECU 2 decides whether the communication unit 23 has received a communication prohibition command from the gateway 10 (Step S10). If a communication prohibition command is not received (NO in Step S10), the processing unit 21 waits until a communication prohibition command is received. If a communication prohibition command is received (YES in Step S10), the processing unit 21 prohibits communication with the other ECUs 2 via the communication unit 23 (Step S11).

Next, the update information receiving unit 21a of the processing unit 21 decides whether the update program transmitted from the gateway 10 is received by the communication unit 23 (Step S12). If the update program is not received (NO in Step S12), the update information receiving unit 21a waits until the update program is received. If the update program is received (YES in Step S12), the update information receiving unit 21a temporarily stores the received update program in the buffer or the like. The update processing unit 21b of the processing unit 21 updates the program 22a by storing (overwriting) the received update program in the storage unit 22 (Step S13). The update processing unit 21b decides whether the update of the program 22a is complete (Step S14). If the update is not complete (NO in Step S14), the process goes back to Step S13 and continues the update process.

If the update of the program 22a is complete (YES in Step S14), the processing unit 21 transmits an update completion report to the gateway 10 via the communication unit 23 (Step S15). Thereafter, the processing unit 21 decides whether a communication prohibition cancel command is received from the gateway 10 via the communication unit 23 (Step S16). If a communication prohibition cancel command is not received (NO in Step S16), the processing unit 21 waits until a communication prohibition cancel command is received. If a communication prohibition cancel command is received (YES in Step S16), the processing unit 21 cancels the prohibition of communication and starts to communicate with the other ECUs 2 (Step S17). Then, the process ends.

In the thus configured on-board update system according to this embodiment, the gateway 10 performs the update processes of the plurality of programs 22a (programs or data) in the ECUs 2 installed in the vehicle 1. The gateway 10 acquires update programs (update programs or data) from the external server device 9 by wireless communication via the wireless communication device 3. If more than one ECU 2 needs updating, the gateway 10 acquires an update program for each ECU 2. Alternatively, the on-board update system may be configured to apply one update program to the update process of more than one ECU 2.

If more than one ECU 2 needs updating, the gateway 10 prohibits each ECU 2 to be updated from communicating with any other ECU 2, prior to the start of the update processes of the ECUs 2, by transmitting a communication prohibition command to each ECU 2 to be updated. As an exception, communication indispensable for the update process (i.e., communication between the gateway 10 and each of the ECUs 2 to be updated) may be permitted. In addition, an ECU 2 that needs no update may be permitted to continue communication. After transmitting the communication prohibition command, the gateway 10 transmits the update programs acquired from the server device 9, to the respective ECUs 2 to be updated. The ECUs 2 that have respectively received the update programs from the gateway 10 perform updates of their programs 22a by storing (overwriting) the received update programs in their storage units 22. When the gateway 10 decides that all of the ECUs 2 to be updated have completed the update processes, the gateway 10 cancels the prohibition of communication by transmitting communication prohibition cancel commands to these ECUs 2. Once the prohibition of communication is cancelled, the ECUs 2 provided with the updated programs 22a may start to communicate with the other ECUs 2.

As described above, if more than one ECU 2 needs to be updated simultaneously, this configuration prohibits communication between the ECUs 2 to be updated until all of the ECUs 2 have completed their update processes. It is therefore possible to prevent a trouble caused by an attempt to establish communication between an ECU 2 which has completed an update process and another ECU 2 which has not completed an update process.

In the above-described embodiment, the gateway 10 installed in the vehicle 1 is configured to acquire update programs from the server device 9 and to transmit the update programs to the ECUs 2. Namely, the gateway 10 is configured to serve as the on-board update device. However, the on-board update device is not limited to the gateway 10, and may be any one of the ECUs 2, the wireless communication device 3, or any other on-board device. Further, the gateway 10 is configured to acquire the update programs from the external server device 9 by wireless communication, but the update programs may be acquired in any other manner. For example, the gateway 10 may be configured to retrieve an update program from a recording medium on which the update program is recorded. Furthermore, the communication devices to be updated is not limited to the ECUs 2, but may be various communication devices other than the ECUs 2. Additionally, the communication in the vehicle 1 between the gateway 10 and the ECUs 2 or the like is not limited to wired communication and may be wireless communication. Lastly, in the on-board update system according to the present embodiment, it is not essential to supply the gateway 10 with the IG signal from the IG switch 4 and with the battery level detection result of the battery 5 from the battery level detection unit 6.

### Embodiment 2

In the on-board update system according to Embodiment 2, the gateway 10 is configured to make a backup of the pre-update program 22a, in case of a failure in the update process of each ECU 2. The update process may fail, for example, if the level of the battery 5 drops critically during the update process, if the update program is lost due to a communication error between the gateway 10 and the ECU 2 during the update process, or if the ECU 2 stops its operation during the update process.

To prepare for such a failure, the gateway 10 in the on-board update system according to Embodiment 2 makes a backup of the pre-update program 22a in the following manner. First, the gateway 10 transmits a communication prohibition command to each ECU 2 to be updated, and then instructs each ECU 2 to transmit its program 22a stored in the storage unit 22 to the gateway 10. Each ECU 2 receiving this transmission command retrieves the program 22a from the storage unit 22 and transmits the retrieved program 22a to the gateway 10. The gateway 10 receives the program 22a transmitted from each ECU 2 and stores this pre-update program 22a in the storage unit 12 as a backup. After the gateway 10 has finished making backups of the programs 22a for all of the ECUs 2 to be updated, the gateway 10 transmits the update programs that have been acquired from the server device 9, to the ECUs 2 to be updated, and thereby enables the update processes at the ECUs 2.

Thereafter, the gateway 10 decides whether the update process of each ECU 2 has failed or not. The gateway 10 may decide that the update process has failed, for example, if receiving an update failure report from the ECU 2 or if not receiving an update completion report from the ECU 2 within a predetermined period. If even one of the plurality of ECUs 2 to be updated fails in the update process, the gateway 10 interrupts the update processes of the ECUs 2. Then, the pre-update programs 22a stored as backups in the storage unit 12 are transmitted from the gateway 10 to the corresponding ECUs 2, so that all of the ECUs 2 to be updated can recover the pre-update state. After all of the ECUs 2 have completed their recovery processes, the gateway 10 transmits communication prohibition cancel commands thereto.

After the failure in an update process, the gateway 10 may try the update processes again at any timing. In this case, the gateway 10 may restart the update processes either at the step of acquiring the update programs from the server device 9, or by using the update programs stored in the storage unit 12 without acquiring the update programs from the server device 9. Regarding the pre-update programs 22a acquired from the ECUs 2 and stored in the storage unit 12, the gateway 10 needs to keep the pre-update programs 22a in the storage unit 12 at least until the completion of the update processes, but may delete the pre-update programs 22a from the storage unit 12 at any timing after the completion of the update processes.

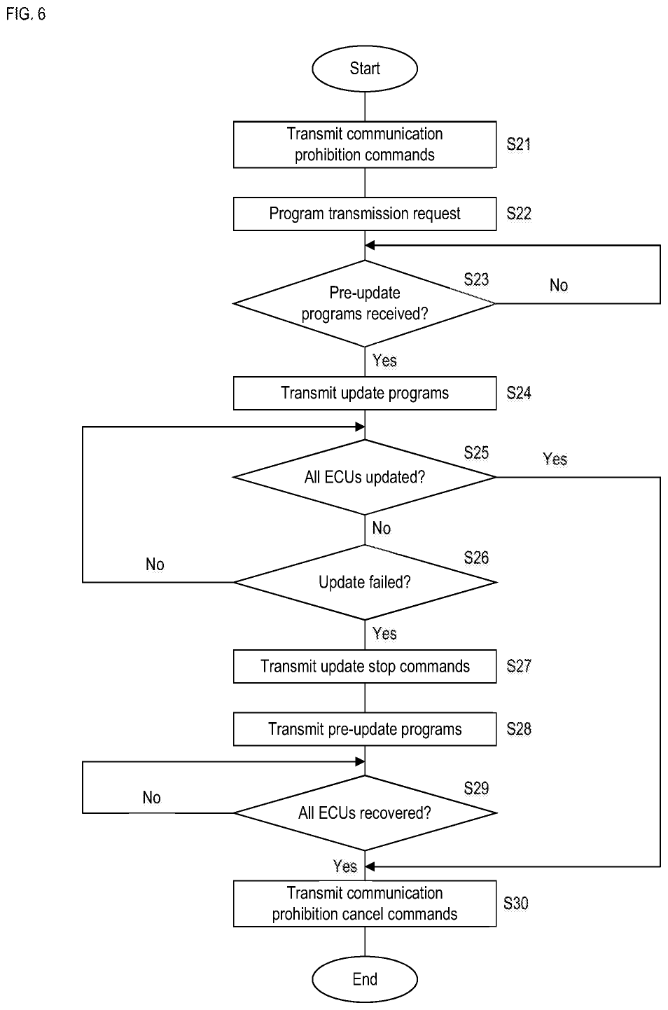

FIG. 6 is a flowchart of the update process, showing process steps performed by the gateway 10 according to Embodiment 2. This flowchart omits the process steps for acquiring update programs from the server device 9 (Steps S1-S4 in the flowchart of FIG. 4) and shows the process steps after the transmission of communication prohibition commands to the ECUs 2. After the gateway 10 has acquired the update programs from the server device 9, communication prohibition commands to prohibit communication between each ECU 2 to be updated and any other ECU 2 are transmitted from the prohibition processing unit 11b of the processing unit 11, via the in-vehicle communication units 13, to the ECUs 2 to be updated (Step S21).

Next, the processing unit 11 requests each ECU 2 to be updated to transmit its program 22a stored in the storage unit 22 (Step S22). In response to this request, each ECU 2 transmits the pre-update program 22a via the in-vehicle communication unit 13 to the processing unit 11. The received pre-update program 22a is stored in the storage unit 12. Then, the processing unit 11 decides whether the pre-update programs 22a have been received from all of the ECUs 2 to be updated (Step S23). If not all of the pre-update programs 22a have been received (NO in Step S23), the processing unit 11 waits until all of the pre-update programs 22a are received.

If all of the pre-update programs 22a have been received (YES in Step S23), the update information transmission unit 11c of the processing unit 11 transmits the update programs that have been acquired from the server device 9 and stored in the storage unit 12, to the ECUs 2 to be updated (Step S24). The completion decision unit 11d of the processing unit 11 checks whether it has received update completion reports from all of the ECUs 2 to be updated, and thereby decides whether all of the ECUs 2 have completed their update processes (Step S25). If all of the ECUs 2 have completed the update processes (YES in Step S25), the prohibition cancelling unit 11e of the processing unit 11 transmits communication prohibition cancel commands to cancel the prohibition of communication, to the ECUs 2 to which the communication prohibition commands have been transmitted in Step S21 (Step S30). Then, the process ends.

If not all of the ECUs 2 have completed their update processes (NO in Step S25), the processing unit 11 decides whether any update process has failed, based on whether an update failure report has been received from any of the ECUs 2 to be updated (Step S26). If no update process has failed (NO in Step S26), the process goes back to Step S25. If any update process has failed (YES in Step S26), the processing unit 11 transmits commands to stop the update processes to all of the ECUs 2 to be updated (Step S27). Then, the processing unit 11 retrieves the pre-update programs 22a stored in the storage unit 12 and transmits these programs back to the respective ECUs 2 (Step S28). The ECUs 2 perform recovery processes using the pre-update programs. Later, the processing unit 11 in the gateway 10 checks whether it has received recovery completion reports from all of the ECUs 2, and thereby decides whether all of the ECUs 2 have completed their recovery processes (Step S29). If not all of the ECUs 2 have completed the recovery processes (NO in Step S29), the processing unit 11 waits until the recovery processes are complete. If all of the ECUs 2 have completed the recovery processes (YES in Step S29), the prohibition cancelling unit 11e of the processing unit 11 transmits communication prohibition cancel commands to cancel the prohibition of communication, to the ECUs 2 to which the communication prohibition commands have been transmitted in Step S21 (Step S30). Then, the process ends.

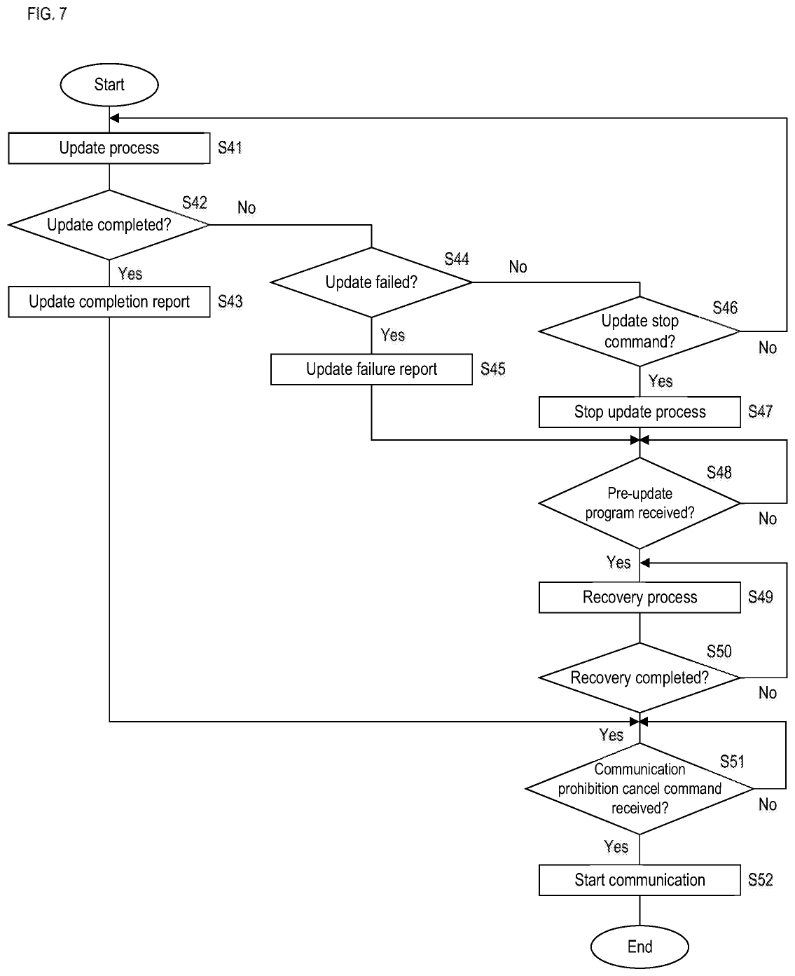

FIG. 7 is a flowchart of the update process, showing process steps performed by each ECU 2 according to Embodiment 2. This flowchart omits the process steps before the ECU 2 receives an update program from the gateway 10 (Steps S10-S12 in the flowchart of FIG. 5) and focuses on the process steps after the ECU 2 starts the update process using the received update program. After each ECU 2 has received the update program transmitted from the gateway 10, the update processing unit 21b of the processing unit 21 updates the program 22a by storing (overwriting) the received update program in the storage unit 22 (Step S41). The update processing unit 21b decides whether the update of the program 22a is complete (Step S42). If the update of the program 22a is complete (YES in Step S42), the processing unit 21 transmits an update completion report to the gateway 10 via the communication unit 23 (Step S43), and proceeds to Step S51.

If the update of the program 22a is not complete (NO in Step S42), the processing unit 21 decides whether the update process has failed (Step S44). If the update process has failed (YES in Step S44), the processing unit 21 reports the failed update process to the gateway 10 (Step S45), and proceeds to Step S48. If the update process has not failed (NO in Step S44), the processing unit 21 decides whether it has received a command to stop the update process from the gateway 10 (Step S46). If no update stop command has been received (NO in Step S46), the process goes back to Step S41. If an update stop command has been received (YES in Step S46), the processing unit 21 stops the update process (Step S47), and proceeds to Step S48.

After Step S45 or S47, the processing unit 21 decides whether it has received the pre-update program 22a from the gateway 10 (Step S48). If no pre-update program 22a has been received (NO in Step S48), the processing unit 21 waits until the pre-update program 22a is received. If the pre-update program 22a has been received (YES in Step S48), the processing unit 21 performs a recovery process by storing (overwriting) the received pre-update program 22a in the storage unit 22 (Step S49). The processing unit 21 then decides whether the recovery process is complete (Step S50). If the recovery process is not complete (NO in Step S50), the process goes back to Step S49 to continue the recovery process.

If the recovery process is complete (YES in Step S50), the processing unit 21 decides whether it has received a communication prohibition cancel command from the gateway 10 via the communication unit 23 (Step S51). If no communication prohibition cancel command has been received (NO in Step S51), the processing unit 21 waits until a communication prohibition cancel command is received. If a communication prohibition cancel command has been received (YES in Step S51), the processing unit 21 cancels the prohibition of communication and starts to communicate with the other ECUs 2 (Step S52). Then, the process ends.

In the thus configured on-board update system according to Embodiment 2, the gateway 10 acquires the pre-update programs 22a stored in the storage units 22 of the ECUs 2 to be updated, and stores the pre-update programs 22a in the storage unit 12 until the ECUs 2 have completed their update processes. If an update process has failed in any of the ECUs 2, the gateway 10 transmits the stored pre-update programs 22a to the respective ECUs 2. Eventually, the ECU 2 that has failed in the update process can acquire the pre-update program 22a from the gateway 10, and can recover the pre-update state.

In Embodiment 2, the gateway 10 starts the recovery process immediately after an update process has failed in any of the ECUs 2, by transmitting the pre-update programs 22a to the ECUs 2. But the start timing of the recovery process is not limited thereto. After the gateway 10 decides that the update process has failed in any of the ECUs 2, the gateway 10 may suspend the recovery process until a predetermined timing comes, for example, when the IG switch 4 is changed from off to on. Alternatively, when an update process has failed, the gateway 10 may repeat the update process several times. If the update process is still unsuccessful despite the repeated attempts, the gateway 10 may start the recovery process.

The other configurations in the on-board update system according to Embodiment 2 are similar to those in the on-board update system according to Embodiment 1. Hence, like components are given like reference numerals to omit their detailed description.

### Embodiment 3

In the on-board update system according to Embodiment 2, the gateway 10 is configured to make backups of the pre-update programs 22a and thereby to enable recovery of the ECUs 2 when any of the update processes is unsuccessful. However, the recovery process is not limited to this configuration.

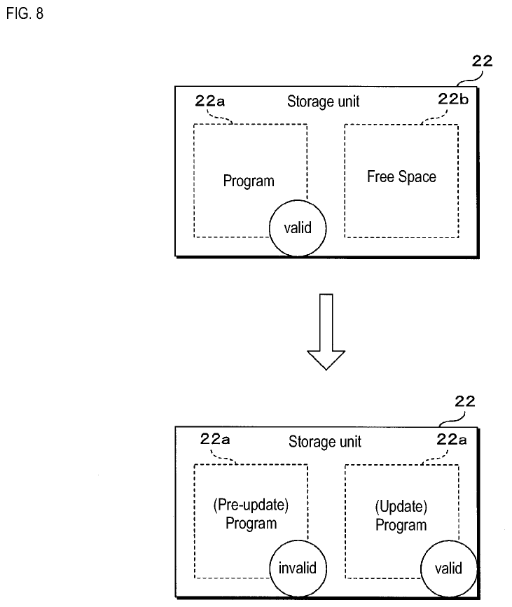

In the on-board update system according to Embodiment 3, each of the ECUs 2 keeps its own pre-update program 22a so as to enable the recovery process when any update process is unsuccessful. FIG. 8 is a schematic view for describing the update process performed by each ECU 2 according to Embodiment 3. The storage unit 22 of the ECU 2 according to Embodiment 3 has a storage capacity sufficient for at least two sets of the program 22a. In the example of FIG. 8, the storage unit 22 at the top includes a program 22a and a free space 22b of substantially equal capacity. In this state, the program 22a stored in the storage unit 22 is valid, and the processing unit 21 retrieves and runs this program 22a.

When the ECU 2 receives an update program from the gateway 10, the ECU 2 stores the received update program 22a in the free space 22b of the storage unit 22, instead of overwriting the pre-update program 22a. If the ECU 2 has successfully stored the update program 22a in the storage unit 22 without error, the ECU 2 invalidates the pre-update program 22a and validates the newly stored update program 22a, thereby completing the update process. Thereafter, the processing unit 21 in the ECU 2 retrieves and runs the validated update program 22a. The invalidated pre-update program 22a may be deleted, for example, at a suitable timing. Instead, the invalidated pre-update program 22a may be kept in the storage unit 22 without being deleted and, for example, may serve as the free space 22b in the next update process.

In this configuration, if an error or any abnormality occurs before the update program 22a has been successfully stored in the free space 22b of the storage unit 22, the ECU 2 keeps the pre-update program 22a valid and stops the update process. The ECU 2 also reports a failed update process to the gateway 10. If at least one ECU 2 fails in the update process, the gateway 10 gives commands to stop the update processes, to the plurality of ECUs 2 to be updated. On receiving the update stop command, even an ECU 2 that has successfully completed its own update process validates the pre-update program 22a stored in the storage unit 22 and invalidates the newly stored update program 22a, thereby recovering the pre-update state.

In the thus configured on-board update system according to Embodiment 3, the storage unit 22 of the ECU 2 at least includes an area for storing the pre-update program 22a (the first area) and an area for storing the update program 22a (the second area). Namely, the storage unit of each ECU 2 has a storage area that is capable of storing at least two sets of programs 22a. The ECU 2 receives the update program 22a transmitted for the update process from the gateway 10, and stores the received update program 22a in the area different from the one storing the pre-update program 22a. Thus, the ECU 2 stores the update program 22a in the storage unit 22 without overwriting the pre-update program 22a. After storing the update program 22a in the storage unit 22, each ECU 2 invalidates the pre-update program 22a and validates the update program 22a, thereby completing the update process. If any update process is unsuccessful, each ECU 2 validates the pre-update program 22a kept in the storage unit 22 and can thereby keep the pre-update state.

Incidentally, the configuration of Embodiment 2 and that of Embodiment 3 may be combined. For example, the configuration of Embodiment 3 may be applied to an ECU 2 that has a sufficient storage capacity in the storage unit 22, and the configuration of Embodiment 2 may be applied to the other ECUs 2 so as to cause the gateway 10 to make backups of the pre-update programs 22a.

The other configurations in the on-board update system according to Embodiment 3 are similar to those in the on-board update system according to Embodiment 1. Hence, like components are given like reference numerals to omit their detailed description.

### Embodiment 4

In the on-board update system according to Embodiment 1, the gateway 10 is configured to start the update processes of the ECUs 2 immediately after the gateway 10 has acquired the update programs from the server device 9. However, the start timing of the update processes is not limited thereto.

In the on-board update system according to Embodiment 4, the gateway 10 acquires the update programs from the server device 9 and stores the update programs in the storage unit 12. Later, the gateway 10 starts the update processes at a predetermined timing, by transmitting the stored update programs to the ECUs 2 to be updated. When the IG switch 4 in the vehicle 1 is on, the gateway 10 in the on-board update system according to Embodiment 4 checks the necessity of updates and acquires update programs by establishing communication with the server device 9 via the wireless communication device 3.

At a predetermined time (e.g., 3:00 am) after the acquisition of the update programs from the server device 9, the gateway 10 starts the update processes of the ECUs 2 when the IG switch 4 is off, by transmitting the update programs stored in the storage unit 12 to the ECUs 2 to be updated. For this operation, the processing unit 11 in the gateway 10 according to Embodiment 4 has either a clock function for counting the time or a time acquisition function by receiving GPS (Global Positioning System) signals. The predetermined time to start the update processes may be set by a user of the vehicle 1 to an optional time (e.g., the time when the user is not likely to use the vehicle 1).

However, this configuration requires consideration in the following respect. When the IG switch 4 is off, the engine or a like part in the vehicle 1 is not in operation, and an alternator generates no power. During this period, the gateway 10 and the ECUs 2 operate on the electric power charged in the battery 5. In the case where the electric power charged in the battery 5 is consumed in the update processes of the ECUs 2, the battery 5 may no longer have sufficient electric power left, for example, to start the engine of the vehicle 1 when the IG switch 4 is changed from off to on. In the on-board update system according to Embodiment 4, the amount of electric power charged in the battery 5 is detected by the battery level detection unit 6 and reported to the gateway 10. If the IG switch 4 is off at the predetermined time, the gateway 10 decides whether the level of the battery 5 is higher than a threshold value. Only if the battery level is higher than the threshold value, the gateway 10 starts the update processes of the ECUs 2.

If the level of the battery 5 is not higher than the threshold value, the gateway 10 does not perform the update processes of the ECUs 2 at this timing. Later, when the IG switch 4 is changed from off to on, the gateway 10 starts the update processes of the ECUs 2 by transmitting the update programs stored in the storage unit 12 to the ECUs 2 to be updated.

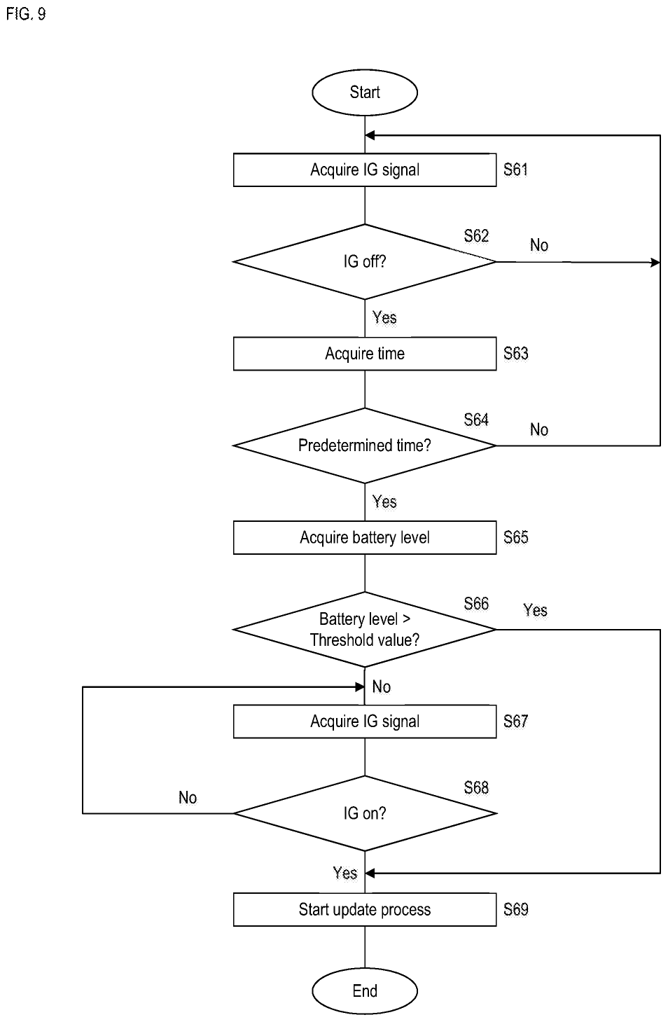

FIG. 9 is a flowchart of the update process, showing process steps performed by the gateway 10 in the on-board update system according to Embodiment 4. This flowchart focuses on the process steps after the gateway 10 has acquired the update programs from the server device 9 and until the gateway 10 starts to transmit the update programs to the ECUs 2, namely, the process steps to be done between Steps S4 and S5 in the flowchart of FIG. 4. The other process steps (the process steps of Steps S1-S4 and the process steps of Steps S5-S8 in FIG. 4) are omitted. The processing unit 11 in the gateway 10, which has received the update programs from the server device 9, acquires an IG signal from the IG switch 4 (Step S61). The processing unit 11 decides whether the acquired IG signal is off (Step S62). If the IG signal is not off (NO in Step S62), the process goes back to Step S61.

If the IG signal is off (YES in Step S62), the processing unit 11 acquires the time, for example, based on its own clock function (Step S63). Then, the processing unit 11 decides whether the acquired time has reached a predetermined time (e.g., 3:00 a.m.) (Step S64). If the acquired time has not reached the predetermined time (NO in Step S64), the process goes back to Step S61.

If the acquired time has reached the predetermined time (YES in Step S64), the processing unit 11 acquires the level of the battery 5 detected by the battery level detection unit 6 (Step S65). The processing unit 11 decides whether the acquired level of the battery 5 is higher than a threshold value (e.g., 50%) (Step S66). If the level of the battery 5 is higher than the threshold value (YES in Step S66), the processing unit 11 starts the update processes of the ECUs 2 to be updated (Step S69). Then, the process ends.

If the level of the battery 5 is not higher than the threshold value (NO in Step S66), the processing unit 11 acquires an IG signal that indicates the state of the IG switch 4 in the vehicle 1 (Step S67). Based on the acquired IG signal, the processing unit 11 decides whether the IG switch 4 is on (Step S68). If the IG switch 4 is not on (NO in Step S68), the processing unit 11 waits until the IG switch 4 is turned on. If the IG switch 4 is on (YES in Step S68), the processing unit 11 starts the update processes of the ECUs 2 to be updated (Step S69). Then, the process ends.

In the thus configured on-board update system according to Embodiment 4, the gateway 10 acquires an IG signal that indicates the state of the IG switch 4 in the vehicle 1. If the IG signal is on, the gateway 10 acquires the update programs from the external server device 9. Later, when the IG signal is off or when the IG signal has changed from off to on, the gateway 10 performs the update processes of the ECUs 2, using the acquired update programs. In the thus configured gateway 10, the update programs can be acquired from the server device 9 while the engine or a like part of the vehicle 1 is in operation to ensure sufficient power supply, and the update processes of the ECUs 2 can be performed while the vehicle 1 is not moving or before the vehicle starts moving.

Further, the gateway 10 acquires information on the level of the battery 5 in the vehicle 1 from the battery level detection unit 6. Based on the level of the battery 5, the gateway 10 decides when to perform the update processes of the ECUs 2, from when the IG signal is off or when the IG signal has changed from off to on. For example, if the battery level is higher than the threshold value, the gateway 10 performs the update processes when the IG signal is off. If the battery level is lower than the threshold value, the gateway 10 performs the update processes when the IG signal has changed from off to on. This configuration can prevent, for example, the battery from running out during the update processes or from getting too low to start the engine of the vehicle 1, or other like problems.

Furthermore, the gateway 10 acquires the time information by a function (e.g., the clock function) of the processing unit 11, and performs the update processes of the ECUs 2 according to the time information. For example, the gateway 10 performs the update processes at the time when the user is unlikely to use the vehicle 1 (e.g., 3:00 a.m.). Eventually, the user is less likely to use the vehicle 1 while the update processes of the ECUs 2 are in progress.

In Embodiment 4, the gateway 10 is configured to start the update processes of the ECUs 2 at a predetermined time while the IG switch 4 is off. However, the start timing of the update processes is not limited thereto. For example, the gateway 10 may start the update processes of the ECUs 2, omitting the decision on the condition of predetermined time, when the IG switch 4 is changed from on to off or when a predetermined time has passed since the IG switch 4 was changed to off.

The other configurations in the on-board update system according to Embodiment 4 are similar to those in the on-board update system according to Embodiment 1. Hence, like components are given like reference numerals to omit their detailed description.

1. An on-board update device which has one or more in-vehicle communication units for communicating with a plurality of communication devices installed in a vehicle, and which is configured to update a program or data stored in a storage unit of each communication device,
the on-board update device comprising:
an update information acquisition unit configured to acquire one or more update programs or data from a device outside the vehicle;
a prohibition processing unit which, if more than one of the communication devices needs updating, is configured to prohibit communication between each of the communication devices to be updated and any other communication device;
an update information transmission unit configured to transmit the one or more update programs or data acquired by the update information acquisition unit, via the one or more in-vehicle communication units to the corresponding communication devices to be updated, after the prohibition processing unit has prohibited communication;
a completion decision unit configured to decide whether each of the communication devices to be updated has completed an update of the program or data; and
a prohibition cancelling unit configured to cancel the prohibition of communication between each of the communication devices to be updated and any other communication device, if the completion decision unit decides that all of the communication devices to be updated have completed their updates.

2. The on-board update device according to claim 1, further comprising:
a pre-update information acquisition unit configured to acquire pre-update programs or data stored in the storage units of the communication devices to be updated; and
a pre-update information storage unit configured to store the programs or data acquired by the pre-update information acquisition unit,
wherein the pre-update information storage unit configured to store the programs or data of the communication devices to be updated, until the completion decision unit decides that the communication devices to be updated have completed the updates.

3. The on-board update device according to claim 2, further comprising:
a failure decision unit configured to decide whether any of the communication devices to be updated has failed in their update process; and
a pre-update information transmission unit which transmits, when the failure decision unit decides that any of the communication devices to be updated has failed in their update, the programs or data stored in the pre-update information storage unit to the corresponding communication devices to be updated.

4. The on-board update device according to claim 1,
further comprising an IG (ignition) state acquisition unit configured to acquire a state of an IG signal in the vehicle,
wherein the update information acquisition unit is configured to acquire the one or more update programs or data when the IG signal is on, and
wherein the update information transmission unit is configured to transmit the one or more update programs or data when the IG signal is off or when the IG signal has changed from off to on.

5. The on-board update device according to claim 4,
further comprising a battery information acquisition unit configured to acquire information on a battery level of the vehicle,
wherein the update information transmission unit configured to decide when to transmit the update programs or data, from when the IG signal is off or when the IG signal has changed from off to on, depending on the battery level acquired by the battery information acquisition unit.

6. The on-board update device according to claim 4,
further comprising a time information acquisition unit configured to acquire time-related information,
wherein the update information transmission unit configured to transmit the update programs or data, according to the information acquired by the time information acquisition unit.

7. An on-board update system comprising a plurality of communication devices installed in a vehicle, one or more in-vehicle communication units for communicating with the communication devices, and an on-board update device for updating a program or data stored in a storage unit of each communication device,
wherein the on-board update device comprises: an update information acquisition unit configured to acquire one or more update programs or data from a device outside the vehicle; a prohibition processing unit which, if more than one of the communication devices needs updating, is configured to prohibit communication between each of the communication devices to be updated and any other communication device; an update information transmission unit configured to transmit the one or more update programs or data acquired by the update information acquisition unit, via the one or more in-vehicle communication units to the corresponding communication devices to be updated, after the prohibition processing unit has prohibited communication; a completion decision unit configured to decide whether each of the communication devices to be updated has completed an update of the program or data; and a prohibition cancelling unit configured to cancel the prohibition of communication between each of the communication devices to be updated and any other communication device, if the completion decision unit decides that all of the communication devices to be updated have completed their updates,
wherein each of the communication devices comprises an update information receiving unit for receiving an update program or data from the on-board update device, and an update processing unit for performing an update by storing the update program or data received by the update information receiving unit, and
wherein each of the communication devices configured to stop data transmission to any other communication device if the on-board update device prohibits the communication.

8. The on-board update system according to claim 7,
wherein the storage unit in each communication device at least comprises a first area for storing a pre-update program or data, and a second area for storing an update program or data,
wherein, in the second area, the update processing unit of each communication device is configured to store the update program or data received by the update information receiving unit, and,
wherein, when the update program or data is completely stored in the second area, the update processing unit of each communication device is configured to invalidate the pre-update program or data stored in the first area.

9. A communication device update method for updating a program or data stored in a storage unit in each of a plurality of communication devices installed in a vehicle,
the method comprising the steps of:
acquiring one or more update programs or data from a device outside the vehicle;
if more than one of the communication devices needs updating, prohibiting communication between each of the communication devices to be updated and any other communication device;
after the communication is prohibited, transmitting the one or more acquired update programs or data to the corresponding communication devices to be updated;
deciding whether the communication devices to be updated have completed updates of the corresponding programs or data; and
if the decision step decides that all of the communication devices to be updated have completed the respective updates, cancelling the prohibition of communication between each of the communication devices to be updated and any other communication device.

10. The on-board update device according to claim 2,
further comprising an IG (ignition) state acquisition unit configured to acquire a state of an IG signal in the vehicle,
wherein the update information acquisition unit is configured to acquire the one or more update programs or data when the IG signal is on, and
wherein the update information transmission unit is configured to transmit the one or more update programs or data when the IG signal is off or when the IG signal has changed from off to on.

11. The on-board update device according to claim 3,
further comprising an IG (ignition) state acquisition unit configured to acquire a state of an IG signal in the vehicle,
wherein the update information acquisition unit is configured to acquire the one or more update programs or data when the IG signal is on, and
wherein the update information transmission unit is configured to transmit the one or more update programs or data when the IG signal is off or when the IG signal has changed from off to on.

12. The on-board update device according to claim 5,
further comprising a time information acquisition unit configured to acquire time-related information,
wherein the update information transmission unit configured to transmit the update programs or data, according to the information acquired by the time information acquisition unit.
